(19) United States
(12) Patent Application Publication
(10) Pub. No.: US 2021/0401011 A1
(43) Pub. Date: Dec. 30, 2021

(54) FRUIT JAM COMPRISING ALLULOSE AND METHOD FOR MANUFACTURING SAME

(71) Applicant: CJ CHEILJEDANG CORPORATION, Seoul (KR)

(72) Inventors: Jong Min CHOI, Suwon-si (KR); Su-Jeong KIM, Suwon-si (KR); Seung Won PARK, Yongin-si (KR); Youn-Kyung BAK, Suwon-si (KR); Jung Gyu PARK, Incheon (KR); Sung Bae BYUN, Sejong (KR); Dong Seok SHIM, Yongin-si (KR); In LEE, Suwon-si (KR); Dong Chul JUNG, Seoul (KR)

(21) Appl. No.: 16/328,635

(22) PCT Filed: Aug. 7, 2017
(86) PCT No.: PCT/KR2017/008489

§ 371 Date: Jun. 10, 2021

(30) Foreign Application Priority Data
Sep. 1, 2016 (KR) 10-2016-0112501

(51) Int. Cl. A23L 21/12; A23L 29/30

(52) U.S. Cl. CPC A23L 21/12; A23V 2002/00; A23L 29/30

(57) ABSTRACT

The present application relates to a fruit jam comprising a fruit and a sugar containing allulose, a method for manufacturing the same, and a method for reducing bubbles in the fruit jam.

### TECHNICAL FIELD

The following disclosure relates to a fruit jam comprising allulose and a method for preparing the same.

### BACKGROUND

Jam is generally prepared by adding a large amount of sucrose to fruit or vegetables, followed by boiling to obtain a highly viscous gel form. Accordingly, since the jam contains a large amount of sucrose, growth of microorganisms is inhibited, and thus, storability is improved, but excessive sucrose intake increases possibilities of cavities, rapid change in blood sucrose, obesity, etc. Further, as a storage period elapses, water which is a dispersion medium contained in the gel is separated from the jam, and thus, microbial stability is reduced. In addition, since sucrose is boiled at a high temperature over a long time according to the conventional methods for preparing the same, a boil-over phenomenon occurs, and bubbles occurring therefrom remain even after cooling, resulting in deterioration of sensory properties. When multiple temperature controls are applied to prevent the boil-over phenomenon, labor and time required for preparing the jam are increased, and nutrients of fruit are destroyed and food texture is lowered.

Allulose is a C-3 epimer of D-fructose and is a natural saccharide ingredient present in trace amounts in raisins, figs, wheat, etc. It has a 70% sweetness compared to sucrose, but has 0 kcal/g of calorie, which is only 5% of the sucrose (4 kcal/g). Thus, the allulose has received attention as a sweetener substitute for sucrose. However, application of allulose to jams has not been reported.

Under these circumstances, the present inventors have made an effort to solve disadvantages of the conventional jams described above. As a result, they found that when the jam was prepared by using the allulose, the boil-over phenomenon, sensory qualities, and storage stability were improved at the time of preparing the jam, and completed the present invention.

### RELATED PRIOR ART DOCUMENT

(Patent Document 1) Korean Patent No. 10-0735865 B1

### SUMMARY

The present invention provides a fruit jam comprising allulose and a method for preparing the same.

According to an exemplary embodiment of the present invention, there is provided a fruit jam including a fruit and a saccharide containing allulose.

Term “fruit” of the present invention means a fruit of a woody plant that is edible, and may include without limitation as long as it is a fruit or vegetable fruit that is usable for preparing a jam. The vegetable fruit (such as strawberry, watermelon, melon, etc.) is a herbaceous cultivated plant that is edible, but treated as a fruit in the common term of the consumer. Thus, the vegetable fruit is defined as being included in the fruit of the present invention. Specifically, the fruit of the present invention includes an orange, tangerine, lemon, grapefruit, peach, apricot, grape, pear, apple, pineapple, strawberry, cranberry, blueberry, acai berry, pomegranate, banana, mango, guava, watermelon, melon, plum, kiwi, or a mixture thereof, but is not limited thereto.

The fruit of the present invention is not limited to raw material from which non-edible portions are removed from a natural fruit, and may include a concentrate or powder thereof. In addition, the fruit used in the present invention may include both the case where the fruit raw material is physically changed or the case where the ingredients included in the fruit raw material have different ingredients from the fruit raw material due to chemical change in a process (for example, the heating process) for preparing of the fruit jam of the present invention.

The allulose of the present invention may be directly extracted from natural products, chemically synthesized, or prepared by biological methods, but is not limited thereto.

The allulose of the present invention may have an amount of 50 to 300 parts by weight based on 100 parts by weight of the fruit. Specifically, the allulose of the present invention may be included in the fruit jam in an amount of 50-300, 50-250, 50-200, 50-150, 50-125, 50-100, 75-300, 75-250, 75-200, 75-150, 75-125, 75-100, 100-300, 100-250, 100-200, 100-150, 100-125, 125-300, 125-250, 125-200, 125-150, 150-300, 150-250, 150-200, 200-300, 200-250 or 250-300 parts by weight.

The fruit jam of the present invention may further include at least one sweetener other than sucrose, as a saccharide ingredient. The sweetener includes, but is not limited to, known sweeteners (for example, monosaccharides, disaccharides, oligosaccharide, sugar alcohols, and high sweeteners). Specifically, the monosaccharide may be, for example, arabinose, xylose, fructose, tagatose, allose, glucose or galactose, and the disaccharide is a saccharide in which two monosaccharides are combined, such as lactose, maltose, trehalose, turanose, or cellobiose.

The oligosaccharide is a saccharide in which three monosaccharides or more are combined, and may be, for example, fructooligosaccharide, isomaltooligosaccharide, xylooligosaccharide, gentio oligosaccharide, maltooligosaccharide or galactooligosaccharide. The sugar alcohol is a substance formed by reducing a carbonyl group of the saccharide, and may be, for example, erythritol, xylitol, arabitol, mannitol, sorbitol, maltitol or lactitol. The high sweetener is a substance having a sweetness ten times or more than that of sucrose, and may be, for example, aspartame, acesulfame K, rebaudioside A or sucralose. However, these substances are not limited thereto.

The fruit jam may further include pectin, an organic acid or a combination thereof. Specifically, the fruit jam of the present invention may have an acidity of pH 2.0 to 5.0, pH 2.5 to 4.5, or pH 3.0 to 4.0, and may have an acidity of 0.1 to 2.0%, 0.2 to 1.5%, or 0.2 to 1.0%. The fruit jam of the present invention may further include an organic acid (for example, citric acid, malic acid, tartaric acid, oxalic acid or acetic acid) for adjusting pH or acidity, if necessary.

Further, the fruit jam of the present invention may further include a thickening agent (for example, a polysaccharide such as pectin, gelatin, gum, etc.).

The fruit jam of the present invention may contain various other ingredients that are capable of being added to other compositions for eating and drinking in addition to the above-described ingredients.

The fruit jam of the present invention may not include sucrose. This sucrose means sucrose added from the outside except for sucrose included in the fruit or sucrose generated from a fruit during a process for preparing a fruit jam.

The fruit jam of the present invention may have a hardness of 10 to 80 gf and may have a hardness of 10 to 70 gf, 10 to 50 gf, 15 to 80 gf, 15 to 70 gf or 15 to 50 gf.

The fruit jam of the present invention may have a spreadability of 0.5 to 3.0 Δg/Δsec, and specifically, 0.5 to 2.8 Δg/Δsec, 0.5 to 2.0 Δg/Δsec or 0.8 to 2.0 Δg/Δsec.

According to another exemplary embodiment of the present invention, there is provided a method for preparing a fruit jam including (a) contacting a fruit with saccharide containing allulose; and (b) heating the product of step (a).

The method may not include contacting the fruit with sucrose. As demonstrated in the following Examples, the fruit jam may be prepared by replacing the sucrose with the allulose by the preparation method of the present invention. The fruit jam prepared by the preparation method of the present invention may reduce a boil-over phenomenon and a syneresis, while having similar sensory properties to the conventional jam prepared by using sucrose.

The method for preparing a fruit jam according to the present invention is described in detail as follows.

First, a specific fruit is selected and washed with water, and non-edible portions (for example, stem end, skin or seed) are removed and then crushed. A saccharide containing allulose may be added at a specific weight ratio with respect to a weight ratio of the crushed fruit, followed by mixing and heating for a predetermined time, and then cooling at room temperature to prepare the fruit jam.

The heating of the present invention may be performed by any known heating method. As a non-limiting example, the heating may be performed for 1 to 10 minutes using a 500 to 1000 W microwave oven or for 5 to 30 minutes using a gas range.

According to still another exemplary embodiment of the present invention, there is provided a method for reducing bubbles of a fruit jam including: (a) contacting a fruit with saccharide containing allulose; and (b) heating the product of step (a).

Since the method for preparing a fruit jam of the present invention is able to use the above-described contents described in connection with the fruit jam as they are, the overlapped description between these two matters is omitted in order to avoid excessive complexity of the present specification.

When comparing the fruit jam of the present invention with the conventional fruit jams prepared by adding sucrose, or sucrose-free fruit jams prepared by using sugar alcohol instead of the sucrose, the fruit jam of the present invention is not prepared by simply replacing the sucrose or the sugar alcohol with the allulose. Those skilled in the art may mix the allulose with natural fruits, but they cannot easily assume how physical properties (pH, acidity, viscosity, flowability and spreadability) of the allulose fruit jam will change due to transformations of the ingredients included in the fruit during the preparation process, and in particular, they cannot easily assume how the degree of the boil-over phenomenon and storage stability will change when preparing the fruit jam using the allulose.

In the present invention, by mixing the allulose with the natural fruit at various ratios, and through an excessive number of repeated experiments, it was possible to complete the allulose fruit jam capable of maintaining a similar level of physical properties to the conventional fruit jams prepared by using the sucrose, preventing nutrient destruction of the fruit and deterioration of food texture while minimizing the boil-over phenomenon and the syneresis.

### Effect of the Present Invention

The fruit jam prepared by using the allulose of the present invention is convenient to prepare because the boil-over phenomenon and bubble occurrence are minimized during preparation as compared to the conventional fruit jams prepared by using sucrose. Further, the sensory quality may be improved, the change of moisture content may be reduced, and the storage stability may be increased, thereby extending the shelf life. In addition, the calorie may be very low, the spreadability may be good, and soft and moist food texture may be maintained, and thus, the sensory quality may be excellent.

### BRIEF DESCRIPTION OF THE DRAWINGS

FIG. 1 is a graph showing hardness and spreadability as physical properties of a fruit jam of the present invention.

FIG. 2 is a graph showing the hardness and spreadability of the fruit jam of the present invention when only sucrose is included.

FIG. 3 is a graph showing the hardness and spreadability of the fruit jam of the present invention when allulose instead of the sucrose is included.

FIG. 4 is a graph of moisture residual rate according to storage periods (0 Day, 3 Day, 7 Day, 16 Day and 30 Day) to show storage stability of the fruit jam of the present invention.

### DETAILED DESCRIPTION OF EMBODIMENTS

Hereinafter, Examples, etc., of the present invention will be described in detail to help the understanding of the present invention. However, the following Examples according to the present invention may be modified into various other embodiments, and should not be interpreted as limiting the scope of the present invention. These Examples of the present invention are provided so that those skilled in the art may more thoroughly understand the present invention.

### EXAMPLE 1

### Preparation of Fruit Jam

Strawberries were prepared as fruits and washed with water, and non-edible portions (stem end, etc.) were removed therefrom. Then, the remaining portions were crushed using a household blender (Vitamix corp., VM0127). After sucrose or allulose was added to the crushed strawberries in a mixing ratio as shown in Table 1 below, each mixture was stored and mixed in a 500 ml glass bottle, heated for 5.5 minutes using a 700 W microwave oven (LG, MM-M301), and cooled for 12 hours at room temperature, thereby preparing a strawberry jam.

TABLE 1

| | | | | Saccharide content relative to |
|---|---|---|---|---|
| Classification | Strawberry (g) | Sucrose (g) | Allulose (g) | strawberry (wt %) |
| Comparative | 100.0 | 100.0 | | 100 |
| Example 1 | | | | |
| Experimental | 160.0 | | 40.0 | 25 |
| Example 1 | | | | |
| Experimental | 133.3 | | 66.7 | 50 |
| Example 2 | | | | |
| Experimental | 100.0 | | 100.0 | 100 |
| Example 3 | | | | |
| Experimental | 66.7 | | 133.3 | 200 |
| Example 4 | | | | |
| Experimental | 50.0 | | 150.0 | 300 |
| Example 5 | | | | |

### EXAMPLE 2

### Measurement of Boil-Over when Preparing Jam

The boil-over phenomenon was observed in the process for preparing a jam of Example 1 above, and a height of bubbles (bubble height) and an amount of bubbles (bubble amount) occurring in the process were measured. The bubble height means a value obtained by subtracting a jam height contained in the container before heating from the maximum height of the bubbles.

As a result, it was confirmed that the bubble height and bubble amount were reduced as an amount in which the allulose was added was increased with respect to the weight of strawberries. Further, Experimental Example 3 in which the same amount of allulose as the sucrose of Comparative Example 1 was added, showed a bubble occurrence effect reduced by about 10% as compared to Comparative Example 1. Thus, it was confirmed that when the jam was prepared by adding the allulose, occurrence of the bubbles was reduced as compared to the jam prepared by using sucrose (Table 2). Therefore, it could be appreciated that by using the allulose instead of sucrose at the time of preparation of the jam, it was possible to reduce the occurrence of bubbles, which facilitates the preparation of jam, and to reduce occurrence of voids caused by the bubbles after cooling.

TABLE 2

| | Bubble occurrence amount | | | | |
|---|---|---|---|---|---|
| | | Jam height | Bubble | | |
| | Base area | before heating | maximum height | Bubble height | Bubble amount |
| Classification | (cm²) | (mm) | (mm) | (mm) | (cm³) |
| Comparative | 136.8 | 18.0 | 163.0 | 145.0 | 1,984.3 |
| Example 1 | | | | | |
| Experimental | 136.8 | 13.0 | 161.0 | 148.0 | 2,025.3 |
| Example 1 | | | | | |
| Experimental | 136.8 | 14.0 | 153.0 | 139.0 | 1,902.2 |
| Example 2 | | | | | |
| Experimental | 136.8 | 18.0 | 149.0 | 131.0 | 1,792.7 |
| Example 3 | | | | | |
| Experimental | 136.8 | 29.0 | 139.0 | 110.0 | 1,505.3 |
| Example 4 | | | | | |
| Experimental | 136.8 | 40.0 | 138.0 | 98.0 | 1,341.1 |
| Example 5 | | | | | |

### EXAMPLE 3

### Measurement of Physical Properties (pH, Acidity and Spreadability) of Allulose Jam

3-1. Measurement of pH

10 g of each of Comparative Example 1 and Experimental Examples 1 to 5 was taken and put in a beaker, and distilled water was added thereto to prepare a 10% (w/w) aqueous solution. Each aqueous solution was filtered using a filter paper (Whatman), and pH of the filtered solution was measured using a digital pH meter (Mettler Toledo, Seven Compact with InLab No.1, 150 mm×10).

As a result, there was no significant difference in the pH between Comparative Example and Experimental Examples, and the pH was maintained at 3 to 4, as in commonly distributed jams (Table 3).

TABLE 3

| | Compar. | Exper. | Exper. | Exper. | Exper. | Exper. |
|---|---|---|---|---|---|---|
| Classification | Example 1 | Example 1 | Example 2 | Example 3 | Example 4 | Example 5 |
| pH | 3.2 | 3.2 | 3.2 | 3.3 | 3.4 | 3.5 |

3-2. Measurement of Acidity

The acidity was measured using an alkali titration method. 1 g of each of Comparative Example 1 and Experimental Examples 1 to 5 was taken and put in a beaker, and distilled water was added thereto to prepare a 100-fold diluted aqueous solution (unit: % (w/w)). To the prepared aqueous solution, 0.1N NaOH (purchased from Daejung Chemicals & Metals Co., Ltd.) was added to measure a consumption amount of 0.1N NaOH by titrating until the pH reached 8.2 to 8.3. From the measured values, the acidity of each sample was represented by the following Equation (1) based on the amount of citric acid:

Acidity (%)=V×F×A×D×1/S×100 (1)

In the above Equation, each variable is as follows:

V: Consumption amount (mL) of 0.1N NaOH,

F: Titer of 0.1N NaOH

A: Citric acid coefficient 0.0064

D: Dilution factor, S: Collection amount of sample (mL)

As a result, the acidity of the jam prepared by using the allulose was not significantly different from the acidity of the jam prepared by using the sucrose, and maintained to be 2% or less as in the commonly distributed jams (Table 4).

TABLE 4

| | Compar. | Exper. | Exper. | Exper. | Exper. | Exper. |
|---|---|---|---|---|---|---|
| Classification | Example 1 | Example 1 | Example 2 | Example 3 | Example 4 | Example 5 |
| Acidity | 0.75% | 1.54% | 1.21% | 0.73% | 0.47% | 0.28% |

3-3. Hardness and Spreadability

The hardness and spreadability of each of Comparative Example 1 and Experimental Examples 1 to 5 were measured using a food texture analyzer (Stable Micro Systems, Taxt Plus). Analysis conditions of the food texture analyzer are shown in Table 5 below.

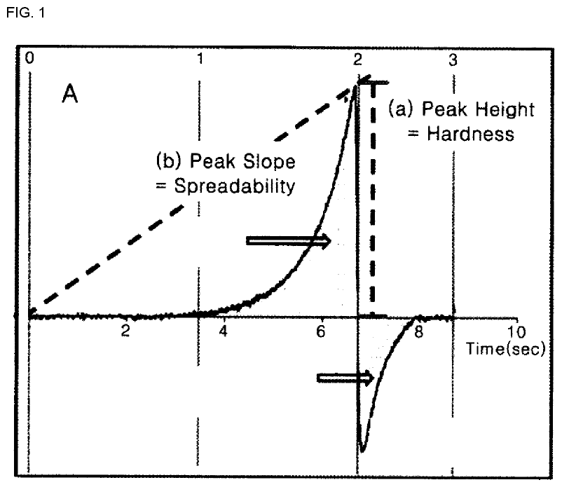

Specifically, each sample of Comparative Example 1 and Experimental Examples 1 to 5 were stored in the same volume in the sample holder of the food texture analyzer so that there was no space. Then, a probe (TTC SPREADABILITY RIG) located at the same height (30 mm) from each sample surface of Comparative Example 1 and Experimental Examples 1 to 5 stored in the sample holder was moved at a constant force and speed (Test Speed and Post Test Speed 1.0 mm/sec) to apply pressure up to a depth of 70% from the point of contact with the sample surface. Here, the maximum intensity of the force in which the probe compressed the sample was regarded as a hardness (force), which is shown as the maximum peak height in FIG. 1. Further, a ratio of a resistance value occurring when the sample was continuously compressed is defined as a spreadability, which is shown as the slope of the peak (Δg/Δsec) in FIG. 1. As the hardness value (gf) is higher, the sample becomes hard, and as the value of the spreadability [Gradient (g/sec)] is lower, the spreadability becomes excellent since resistance is low.

TABLE 5

| Test mode | Compression | |
|---|---|---|
| Probe | TTC SPREADABILITY RIG | |
| Test speed | 1.0 | mm/sec |
| Post-test speed | 1.0 | mm/sec |
| Strain | 70% | |
| Height | 30 | mm |

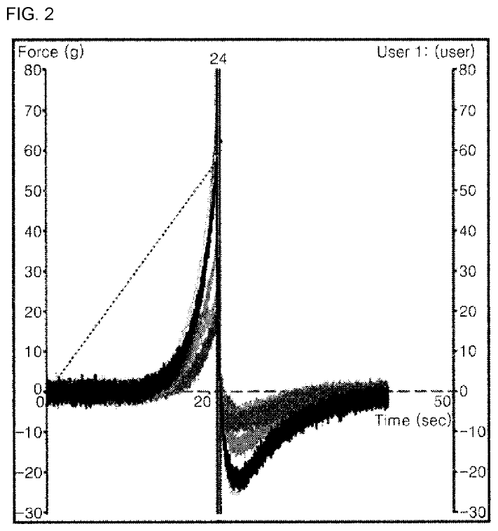

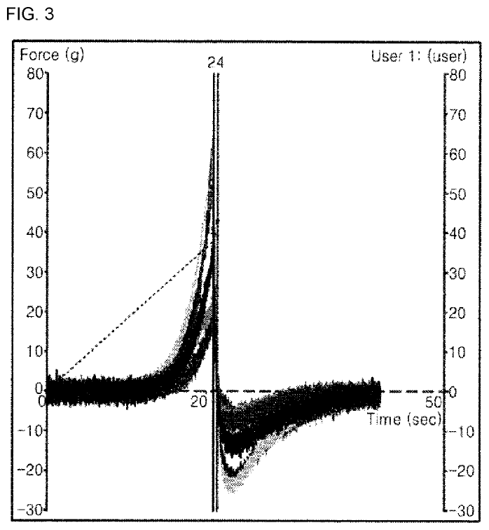

As a result, Experiment Example 3 for a jam which was prepared by using the same amount of allulose as the sucrose of Comparative Example 1, showed lower hardness and spreadability values than those of Comparative Example 1. It was confirmed that Examples 3 to 5 showed equal or higher hardness and spreadability even when comparing with commercially available products (Commercial Product 1: strawberry jam from Ottogi Co., Ltd.; Product 2: strawberry jam from Bokumjari Co., Ltd.) (Table 6, FIGS. 2 and 3).

In detail, in Comparative Example 1, the maximum value of the peak of FIG. 2, that is, the hardness was found to be 59.6, whereas in Experimental Example 3, the maximum value of the peak of FIG. 3 was found to be 38.0. Thus, it was confirmed that the fruit jam prepared by using the same amount of allulose as the sucrose of the conventional fruit jam prepared by using the sucrose, had a relatively low hardness and a soft food texture. In addition, in Comparative Example 1, the peak slope of FIG. 2, that is, the spreadability was found to be 2.9, whereas in Experimental Example 3, the peak slope of FIG. 3 was found to be 1.8. Thus, it was confirmed that the fruit jam prepared by using the same amount of allulose as the sucrose of the conventional fruit jam prepared by using the sucrose, had a low resistance value, resulting in improvement of the spreadability.

TABLE 6

| | Compar. | | | Exper. | Exper. | Exper. | Exper. | Exper. |
|---|---|---|---|---|---|---|---|---|
| Classification | Example 1 | product 1 | product 2 | Example 1 | Example 2 | Example 3 | Example 4 | Example 5 |
| Hardness (gf) | 59.6 | 23.1 | 26.3 | 76.6 | 67.8 | 38.0 | 21.9 | 16.2 |
| Spreadability | 2.9 | 1.1 | 1.9 | 3.5 | 2.7 | 1.8 | 1.1 | 0.8 |
| (Δg/Δsec) | | | | | | | | |

### EXAMPLE 4

### Evaluation of Sensory Properties

The jam samples of Experimental Example 3 and Comparative Example 1 in which allulose and sucrose were added in the same amount were evaluated per item after 24 hours from the completion time point of preparation of the jams by 16 trained male and female panelists in their 20s and 50s, and sensory qualities were compared to each other.

Specifically, each panelist freely applied each jam to bread (commercially available product), ate, and then expressed given properties (spreadability, stickiness, mouth feeling preference, overall preference) according to a 9-point scale. The quantified scores for each property were again converted to a 5-point scale (intensity: 1 point—very weak to 5 points—very strong, preference: 1 point—very poor to 5 points—very good), and the scores for each property were analyzed according to the T-test between the two samples, and statistical significant difference was shown (p<0.05).

As a result, it was confirmed that Experimental Example 3 had excellent spreadability and low stickiness, and thus, showed the same tendency as the spreadability result analyzed by using the food texture analyzer. Experimental Example 3 also showed a relatively good tendency (p<0.1) in the mouth feeling preference, and no significant difference in the overall preference as compared to the Comparative Example (Table 7).

TABLE 7

| | Comparative | Experimental | |
|---|---|---|---|
| Properties | Example 1 | Example 3 | p value |
| Spreadability | 2.92 ± 0.58 | 4.22 ± 0.41 | 0.00 |
| Stickiness | 3.45 ± 0.73 | 2.34 ± 0.68 | 0.00 |
| Mouth feeling preference | 3.53 ± 0.56 | 3.81 ± 0.62 | 0.09 |
| Overall preference | 3.67 ± 0.65 | 3.41 ± 0.71 | 0.32 |

### EXAMPLE 5

### Storage Stability

Storage stability of the prepared jams was confirmed by moisture change within the storage period. In foods having a gel network structure such as a jam, a dispersion medium (mainly water) contained in the gel is separated from the gel during storage and distribution, and the separated dispersion medium promotes microbial contamination and proliferation, resulting in deterioration of quality or increased risk of human body. Therefore, the storage stability is able to be improved when the moisture change is reduced.

Specifically, the moisture change during storage was determined by measuring the moisture content immediately after the preparation of the jam, and by confirming the change in the moisture content generated during the storage under the dehumidification condition. That is, the jam samples of Examples 1 to 5 and Comparative Example 1 were stored in an open state at 20% RH (relative humidity) condition, and some of the samples were taken after 3 days, 7 days, 16 days and 30 days. The moisture content was measured by an atmospheric pressure thermal drying method. 5 g of each of the collected samples were widely applied to a container of which a content was confirmed, and then an amount of reduced moisture was measured by drying at 100 to 103° C. under atmospheric pressure.

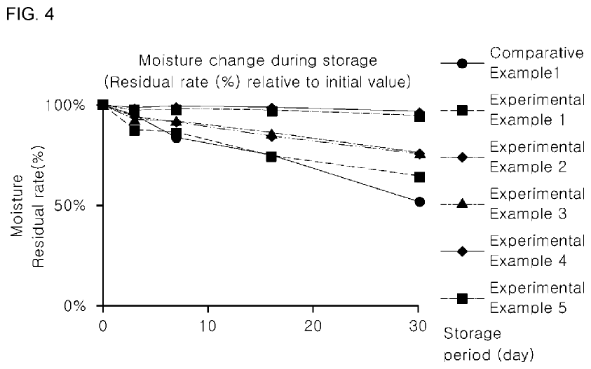

As a result, in Comparative Example 1, it was confirmed that the moisture was continuously lost during storage, and after 30 days, 52.1% of the moisture remained as compared to the initial value. Whereas in Experimental Examples 1 to 5, it was confirmed that 64.5% to 94.5% of the moisture remained, and thus, the moisture residual rate was significantly higher than that of Comparative Example (Table 8, FIG. 4). Experimental Example 3 prepared by adding the same amount of allulose as the sucrose of Comparative Example 1 showed that the moisture residual rate after 30 days was 76%, and a moisture retention force was about 1.46 times or more excellent as compared to Comparative Example 1. Even in Experimental Examples 4 to 5 in which the added amount of allulose was increased, about 94% to 97% or more of moisture remained even after 30 days, and thus, it was confirmed that the addition of allulose reduced the moisture change of the jam.

TABLE 8

| | Moisture content | | | | | |
|---|---|---|---|---|---|---|
| | immediately after | Moisture residual rate according to storage period | | | | |
| Classification | preparation | 0 Day | 3 Day | 7 Day | 16 Day | 30 Day |
| Comparative | 20.0% | 100.0% | 94.9% | 83.6% | 74.6% | 52.1% |
| Example 1 | | | | | | |
| Experimental | 44.9% | 100.0% | 87.5% | 86.3% | 74.6% | 64.5% |
| Example 1 | | | | | | |
| Experimental | 34.6% | 100.0% | 94.3% | 91.5% | 84.2% | 75.5% |
| Example 2 | | | | | | |
| Experimental | 26.8% | 100.0% | 92.9% | 92.5% | 86.2% | 76.0% |
| Example 3 | | | | | | |
| Experimental | 22.2% | 100.0% | 98.5% | 99.0% | 98.6% | 96.6% |
| Example 4 | | | | | | |
| Experimental | 19.5% | 100.0% | 97.4% | 97.7% | 97.0% | 94.5% |
| Example 5 | | | | | | |

While certain embodiments have been described above, it will be understood to those skilled in the art that the invention disclosed herein can be made to the other embodiments without departing from the spirit or the essential features of the invention. In this regard, the above examples described herein are exemplified from every aspect, and should not be interpreted as limiting the scope of the present invention. Accordingly, the scope of the present invention should be defined by the claims appended hereto and their equivalents, rather than by the above detailed description. Also, It should be interpreted that every substitutions and modifications made to the invention are within the scope of the present invention.

What is claimed is:

1. A fruit jam comprising a fruit and a saccharide containing allulose.

2. The fruit jam of claim 1, wherein the allulose has an amount of 50 to 300 parts by weight based on 100 parts by weight of the fruit.

3. The fruit jam of claim 1, wherein the allulose has an amount of 50 to 100 parts by weight based on 100 parts by weight of the saccharide.

4. The fruit jam of claim 1, wherein the fruit jam does not include sucrose.

5. The fruit jam of claim 1, wherein the fruit jam has a hardness of 10 to 80 gf.

6. The fruit jam of claim 1, wherein the fruit jam has a spreadability of 0.5 to 3.0 Δg/Δsec.

7. A method for preparing a fruit jam comprising:
(a) contacting a fruit with a saccharide containing allulose; and
(b) heating the product of step (a).

8. The method of claim 7, wherein the method does not include contacting the fruit with sucrose.

9. A method for reducing bubbles of a fruit jam comprising:
(a) contacting a fruit with a saccharide containing allulose; and
(b) heating the product of step (a).
